(19) United States
(12) Patent Application Publication
(10) Pub. No.: US 2003/0016756 A1
(43) Pub. Date: Jan. 23, 2003

(54) Processing a compressed media signal

(76) Inventors: Frits Anthony Steenhof, Eindhoven (NL); Gerrit Cornelis Langelaar, Eindhoven (NL)

Correspondence Address: U.S. Philips Corporation, 580 White Plains Road, Tarrytown, NY, 10591, US

(21) Appl. No.: 10/196,120

(22) Filed: Jul. 16, 2002

(30) Foreign Application Priority Data
Jul. 19, 2001 (EP) 01202767.8

(51) Int. Cl. H04N 7/12

(52) U.S. Cl. 375/240.25; 380/217

(57) ABSTRACT

A method and arrangement are disclosed for processing a compressed media signal, for example, embedding a watermark in an MPEG2 video signal. The watermark, a spatial noise pattern (140), is embedded (123) by selectively discarding the smallest quantized DCT coefficients. The discarded coefficients are subsequently merged in the runs of other run/level pairs. To compensate for a too large reduction of the bit rate, some of the new run/level pairs are not variable-length encoded (124) but represented by longer code words according to further coding rule (125) providing such longer code words, for example, MPEG's “Escape coding”.

### FIELD OF THE INVENTION

The invention relates to a method and arrangement for processing a compressed media signal in which samples of said media signal are represented by variable-length code words according to a first coding rule, the method comprising the steps of: decoding selected variable-length code words into respective selected signal samples; modifying said selected signal samples in accordance with a given signal processing algorithm; and encoding the modified signal samples into modified variable-length code words according to said first coding rule.

The invention particularly relates to the process of embedding a watermark in an MPEG-encoded video signal, in which the signal samples are DCT coefficients.

### BACKGROUND OF THE INVENTION

A known method of embedding a watermark in a compressed media signal is disclosed in F. Hartung and B. Girod: “Digital Watermarking of MPEG-2 Coded Video in the Bitstream Domain”, published in ICASSP, Vol. 4, 1997, pp. 2621-2624. In this prior-art publication, the media signal is a video signal, the signal samples of which are DCT coefficients obtained by subjecting the image pixels to a Discrete Cosine Transform. The watermark is a DCT-transformed pseudo-noise sequence. The watermark is embedded by adding the DCT-transformed noise sequence to the corresponding DCT coefficients. The zero coefficients of the MPEG-coded signal are not affected.

A problem of the prior-art watermark embedding scheme is that modification of DCT coefficients in an already compressed bit stream changes the bit rate because the DCT coefficients are represented by variable-length code words. An increased bit rate is usually not acceptable. The prior-art embedder therefore checks whether transmission of the watermarked coefficient increases the bit rate and transmits the original coefficient in that case. However, also reduction of the bit rate is not desired. In MPEG systems, for example, a change of the bit rate may result in overflow or underflow of buffers in the decoder and change the position of timing information in the bit stream.

### OBJECT AND SUMMARY OF THE INVENTION

It is an object of the invention to provide a method of embedding a watermark which alleviates the above-mentioned drawbacks.

To this end, the method according to the invention is characterized in that it includes the steps of testing whether said step of encoding decreases the bit rate of the compressed media signal, and, if that is the case, re-encoding a signal sample into a longer code word according to a second coding rule. Said re-encoding into longer code words compensates for the reduction of bit rate caused by the watermarking process. The signal sample being re-encoded is preferably but not necessarily the modified signal sample.

In order to be able to decode the compressed signal, a decoder must know the second coding rule. To this end, the second coding rule can be conveyed in the bit stream. However, the invention is advantageously used in combination with compression standards that already provide such a second coding rule. The MPEG video compression standard is an example thereof. The MPEG standard provides variable-length code words for frequently occurring combinations (pairs) of runs of zero DCT coefficients and a preceding or succeeding non-zero DCT coefficient. For statistically rare run/level pairs, MPEG defines an “Escape coding” method which provides a relatively long fixed-length code word. A preferred embodiment of the invention exploits the insight that MPEG's Escape coding rule may be applied to any run/level pair.

The invention is particularly advantageous if the watermarking process modifies the second value (i.e. a non-zero DCT coefficient) of run/level pairs into the first value (i.e. a zero DCT coefficient). Such a watermarking process is proposed in Applicant's non-published earlier European patent application 01200277.0 (Attorney's docket PHNL 010062). It causes a run/level pair to be modified into a run of zeroes, which is subsequently merged with the run of a succeeding or preceding run/level pair. This reduces the bit rate considerably and justifies re-encoding of the new run/level pair according to the second coding rule so as to compensate for the reduction of bit rate.

### BRIEF DESCRIPTION OF THE DRAWINGS

FIG. 1 shows schematically an arrangement for carrying out the method according to the invention.

FIGS. 2A-2C and 3A-3C show diagrams to illustrate the operation of the arrangement which is shown in FIG. 1.

FIG. 4 shows a flow chart of operations performed by a bit rate control processor which is shown in FIG. 1.

### DESCRIPTION OF A PREFERRED EMBODIMENT

Although the invention is neither restricted to video signals nor to a particular compression standard it will now be described with reference to an arrangement for embedding a watermark in a video signal which is compressed in accordance with the MPEG2 standard. Note that the compressed signal may already have an embedded watermark. In that case, an additional watermark is embedded in the signal. This process of watermarking an already watermarked signal is usually referred to as “remarking”.

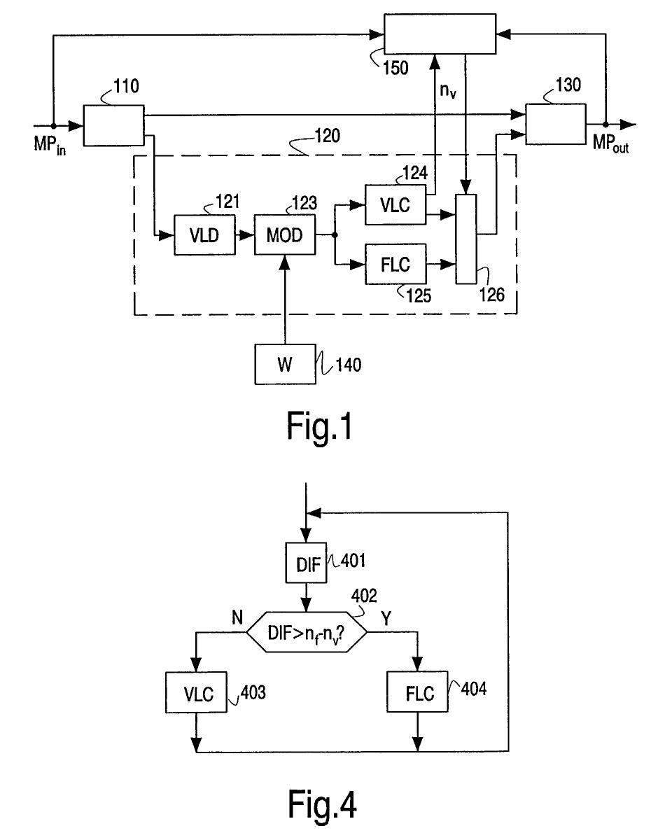

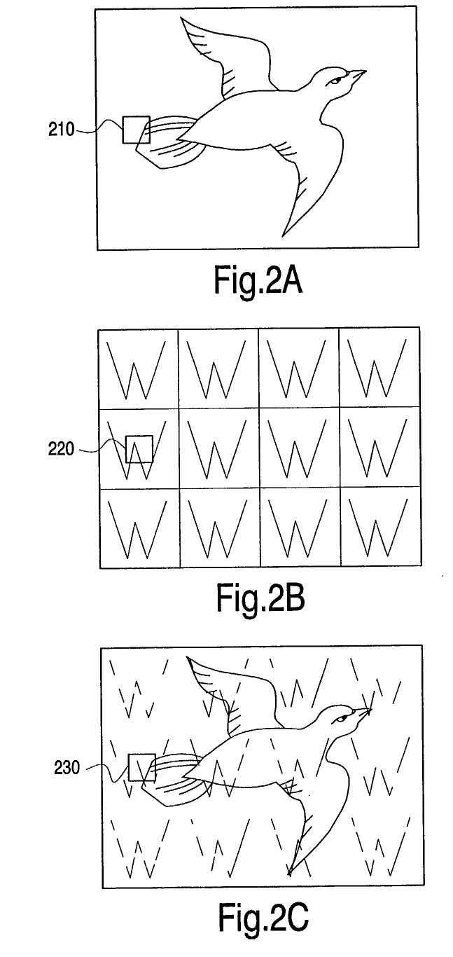

FIG. 1 shows a schematic diagram of an arrangement carrying out a preferred embodiment of the method according to the invention. The arrangement comprises a parsing unit 110, a VLC processing unit 120, an output stage 130, a watermark buffer 140, and a bit rate control processor 150. The operation of the arrangement will be described with reference to FIGS. 2A-2C and 3A-3C.

The arrangement receives an MPEG video stream MPᵢₙ which represents a sequence of video images. One such video image is shown in FIG. 2A by way of illustrative example. The video images are divided into blocks of 8×8 pixels, one of which is denoted 210 in FIG. 2A. The pixel blocks are represented by respective blocks of 8×8 DCT coefficients. The upper left transform coefficient of such a DCT block represents the average luminance of the corresponding pixel block and is commonly referred to as the DC coefficient. The other coefficients represent spatial frequencies and are referred to as AC coefficients. The upper left AC coefficients represent coarse details of the image, the lower right coefficients represent fine details. The AC coefficients are quantized. This quantization process causes many AC coefficients of a DCT block to assume the value zero. FIG. 3A shows a typical example of a DCT block 310 representing image block 210 in FIG. 2A.

The coefficients of the DCT block have been sequentially scanned in accordance with a zigzag pattern (301 in FIG. 3A) and variable-length encoded. The variable-length encoding scheme is a combination of Huffman coding and run-length coding. More particularly, each run of zero AC coefficients and a subsequent non-zero AC coefficient constitutes a run/level pair which is encoded into a single variable-length code word. Reference numeral 311 in FIG. 3A shows the series of run/level pairs representing DCT block 310. An End-Of-Block code (EOB) denotes the absence of further non-zero coefficients in the DCT block. Reference numeral 312 in FIG. 3A shows the corresponding variable-length code words in accordance with the MPEG2 video compression standard.

In an MPEG2 video stream, four such DCT luminance blocks and two DCT chrominance blocks constitute a macroblock, a number of macroblocks constitutes a slice, a number of slices constitutes a picture (field or frame), and a series of pictures constitutes a video sequence. Some pictures are autonomously encoded (I-pictures), other pictures are predictively encoded with motion compensation (P and B-pictures). In the latter case, the DCT coefficients represent differences between pixels of the current picture and pixels of a reference picture rather than the pixels themselves.

The MPEG2 video stream MPin is applied to the parsing unit 110 (FIG. 1). This parsing unit partially interprets the MPEG bit stream and splits the stream into variable-length code words representing luminance DCT coefficients (hereinafter: VLCs) and other MPEG codes. The unit also gathers information such as: the coordinates of the blocks, the coding type (field or frame), the scan type (zigzag or alternate). The VLCs and associated information are applied to the VLC processing unit 120. The other MPEG codes are directly applied to the output stage 130.

The watermark to be embedded is a pseudo-random noise sequence in the pixel domain. In this embodiment of the arrangement, a 128×128 basic watermark pattern is “tiled” over the extent of the image. This tiling operation is illustrated in FIG. 2B. The 128×128 basic pseudo-random watermark pattern is herein shown as a symbol W for better visualization. The spatial noise values of the basic watermark are transformed to the same representation as the video content in the MPEG stream. To this end, the 128×128 basic watermark pattern is likewise divided into 8×8 blocks, one of which is denoted 220 in FIG. 2B. The blocks are discrete cosine-transformed and quantized. Note that the transform and quantizing operation need to be done only once. The DCT coefficients thus calculated are stored in the 128×128 watermark buffer 140 of the arrangement.

The watermark buffer 140 is connected to the VLC processing unit 120, in which the actual embedding of the watermark takes place. The VLC processing unit decodes (121) selected variable-length code words representing the video image into run/level pairs, and converts the run/level pairs into a two-dimensional array of 8×8 DCT coefficients. The watermark is embedded, in a modification stage 123, by adding to each video block the spatially corresponding watermark block. The watermark block 220 (FIG. 2B) is thus added to the spatially corresponding image block 210 (FIG. 2A). This operation is carried out in the DCT domain. In accordance with a preferred embodiment of the invention, only DCT coefficients that are turned into zero coefficients by this operation are selected for the purpose of watermark embedding. For example, the coefficient having the value 2 in FIG. 3A will be modified only if the corresponding watermark coefficient has the value −2. In mathematical notation:

if cᵢₙ(i,j)+w(i,j)=0

then cₒᵤₜ(i,j)=0

else cₒᵤₜ(i,j)=cᵢₙ(i,j)

where cᵢₙ is a coefficient of a video DCT block, w is a coefficient of the spatially corresponding watermark DCT block, and cₒᵤₜ is a coefficient of the watermarked video DCT block. In accordance with a further embodiment, only the signs of the DCT coefficients of the watermark pattern are stored in the watermark buffer 140, so that the buffer stores +1 and −1 values only. This reduces the memory capacity of the buffer to 1 bit per coefficient (128×128 bits in total). Experiments have shown that it is sufficient to apply watermark embedding to the most significant DCT coefficients only (the most significant coefficients are the ones occurring first in the zigzag scan). This reduces the memory requirements even further. FIG. 3B shows a typical example of a watermark block 320 in the DCT domain, corresponding to noise block 220 in FIG. 2B.

FIG. 3C shows a watermarked video DCT block 330, obtained by the above-described “addition” of watermark DCT block 320 to video DCT block 310. It will be appreciated that the number of zero coefficients in the DCT block is increased by this operation. In this specific example, two non-zero coefficients are turned into zero coefficients. They are shaded in FIG. 3C. The new zero coefficients merge into runs of other run/level pairs. Reference numeral 331 in FIG. 3C shows the run/level pairs of the watermarked DCT block 330. The former run/level pairs (1/-1) and (0/2) have been merged into a new run/level pair (2/2), and former run/level pairs (2/1) and (7/-1) have been merged into a new run/level pair (10/-1).

The new run/level pairs are re-encoded. In the arrangement, which is shown in FIG. 1, said re-encoding is performed by a variable-length encoder 124 and a fixed-length encoder 125. The encoders 124 and 125 comply with the relevant compression standard. In this example, they comply with MPEG's DCT coefficients Table, which defines short variable-length code words for frequently occurring run/level pairs and long fixed-length (24-bits) “Escape codes” for other run/level pairs. Reference numeral 332 in FIG. 3C shows the output of variable-length encoder 124 in response to receipt of run/level pairs 331. The watermark embedding process appears to have saved 4 bits, compared with the corresponding input 312 (see FIG. 3A). Similar bit cost reductions may have occurred in previous blocks.

The invention exploits the insight that MPEG's fixed-length “Escape coding” rule may also be applied to run/level pairs having an entry in the variable-length coding table.

The fixed-length encoder 125 produces the fixed-length code word for each (or at least each new) run/level pair. A selector 126 selects the variable-length code word produced by encoder 124 or the longer fixed-length code word produced by encoder 125. The selection is controlled by the bit rate control processor 150.

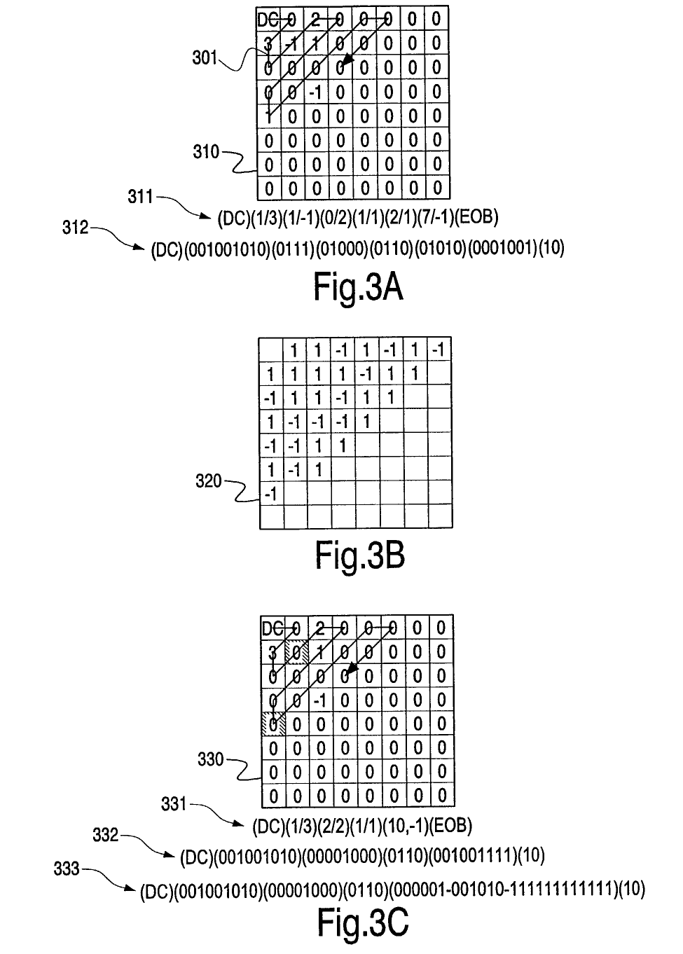

FIG. 4 shows a flow chart of operations performed by the bit rate control processor 150. In a step 401, the processor keeps track of the cumulative difference DIF between the number of bits in input stream MPᵢₙ and the number of bits in output stream MPₒᵤₜ. The processor also receives the lengths nᵥ of the code words produced by VLC encoder 124, and knows the lengths nf (here 24) of the code words produced by FLC encoder 125. As long as the cumulative difference DIF is found to be smaller than n_{f}−nᵥ (in a step 402), the processor controls selector 126 to select the variable-length code word in a step 403. If the cumulative difference exceeds n_{f}−nᵥ, the longer fixed-length code word is selected in a step 404.

Reference numeral 333 in FIG. 3C shows a possible result of this selection process. Selection of the variable-length code word for the new run/level pair (2/2) having length nᵥ=8 causes the cumulative difference to be increased by 1, because the former run/level pairs (1/-1)(0/2) had length 9. Selection of the variable-length code word for the new run/level pair (10/-1) having nᵥ=9 causes the cumulative difference to be increased by 3, because the former run/level pairs (2/1)(7/-1) had length 12. The latter selection brings the cumulative difference in danger of exceeding 15. In response thereto, the processor 150 selects the 24-bit fixed-length code.

The code words thus selected are subsequently applied to the output stage 130, which provides the watermarked output signal MPₒᵤₜ. FIG. 2C shows the watermarked image.

The pixel block denoted 230 in this Figure corresponds to the watermarked video DCT block 330 in FIG. 3C. As has been attempted to express in FIG. 2C, the amount of watermark embedding varies from block to block and from tile to tile.

It is to be noted that it is not necessarily the new run/level pair being created by the watermark embedding process, which is fixed-length encoded. An unmodified run/level pair may be fixed-length encoded as well. Suppose, for example, that the watermark embedding process also turns the last non-zero coefficient of a block (i.e. the coefficient value −1 in FIG. 3A) into a zero coefficient. The respective run/level pair ((7/-1) in FIG. 3A) will then be removed from the bit stream. In that case, it is envisaged to fixed-length encode a former, unmodified, run/level pair (viz. (1/1) in FIG. 3C).

A method and arrangement are disclosed for processing a compressed media signal, for example, embedding a watermark in an MPEG2 video signal. The watermark, a spatial noise pattern (140), is embedded (123) by selectively discarding the smallest quantized DCT coefficients. The discarded coefficients are subsequently merged in the runs of other run/level pairs. To compensate for a too large reduction of the bit rate, some of the new run/level pairs are not variable-length encoded (124) but represented by longer code words according to a further coding rule (125) providing such longer code words, for example, MPEG's “Escape coding”.

1. A method of processing a compressed media signal in which samples of said media signal are represented by variable-length code words according to a first coding rule, the method comprising the steps of:
decoding (121) selected variable-length code words into respective selected signal samples;
modifying (123) said selected signal samples in accordance with a given signal processing algorithm, and
encoding (124) the modified signal samples into modified variable-length code words according to said first coding rule, characterized in that the method includes the steps of testing (402) whether said step of encoding decreases the bit rate of the compressed media signal, and, if that is the case, re-encoding (125) a signal sample into a longer code word according to a second coding rule.

2. The method as claimed in claim 1, wherein said given signal processing algorithm is embedding a watermark (140) in said compressed media signal.

3. The method as claimed in claim 1, wherein said step of re-encoding a signal sample is applied to the modified signal sample.

4. The method as claimed in claim 1, wherein each selected variable-length code word represents a run of signal samples having a first value and a contiguous signal sample having a different, second value, the step of modifying being applied to said contiguous signal sample.

5. The method as claimed in claim 4, wherein said step of modifying is applied to said contiguous signal sample only if the modified contiguous signal sample assumes the first value by said modification.

6. The method as claimed in claim 5, wherein the step of re-encoding comprises the steps of merging the modified contiguous signal sample with a succeeding or preceding run of signal samples to obtain a new run of signal samples, and encoding the new run of signal samples and a further contiguous signal sample having the second value into a new variable-length code word according to the first coding rule.

7. The method as claimed in claim 4, wherein the first value is zero and the signal samples qualified for modification are signal samples having the smallest non-zero value.

8. The method as claimed in claim 1, wherein the media signal is divided into sections and the number of modified contiguous signal samples is limited to a predetermined maximum per section.

9. An arrangement for processing a compressed media signal in which samples of said media signal are represented by variable-length code words according to a first coding rule, the arrangement comprising:
a decoder (121) for decoding selected variable-length code words into respective selected signal samples;
means (123) for modifying said selected signal samples in accordance with a given signal processing algorithm, and
an encoder (124) for encoding the modified signal samples into modified variable-length code words according to said first coding rule, characterized in that the arrangement includes processing means (150) for testing (402) whether said encoding (124) decreases the bit rate of the compressed media signal, and, if that is the case, controlling said encoder to re-encode (125) a signal sample into a longer code word according to a second coding rule.
